(19) United States
(12) Patent Application Publication
(10) Pub. No.: US 2020/0326202 A1
(43) Pub. Date: Oct. 15, 2020

(54) Method, Device and System for Displaying Augmented Reality POI Information

(71) Applicant: Bayerische Motoren Werke Aktiengesellschaft, Muenchen (DE)

(72) Inventors: Maximilian DOEMLING, Shanghai (CN); Tomas XU, Shanghai (CN)

(21) Appl. No.: 16/955,179

(22) PCT Filed: Dec. 21, 2017
(86) PCT No.: PCT/CN2017/117789

§ 371 Date: Jun. 18, 2020

(51) Int. Cl. G01C 21/36; G06K 9/00; G06T 11/00

(52) U.S. Cl. CPC G01C 21/3679; G06T 11/00; G06K 9/00791

(57) ABSTRACT

A method for displaying Point of Interest (POI) information for a vehicle, includes: obtaining a digital map; obtaining localization information of the vehicle; obtaining coordinate information of the POI and type information of the POI from the digital map; receiving reality image data from a camera mounted on the vehicle; transforming the coordinate information of the POI from a coordinate system of the digital map to a coordinate system of the camera; generating a guide sign indicating the POI in the coordinate system of the camera based on the coordinates information of the POI transformed to the coordinate system of the camera and the type information of the POI; and superimposing the guide sign indicating the POI on the image data received from the camera.

### FIELD OF THE INVENTION

The present invention relates in general to the field of augmented reality navigation systems, and in more particular, to a method and an apparatus for displaying Point of Interest (POI) information for a vehicle.

### BACKGROUND

A conventional navigation apparatus displays the current position of a vehicle which is determined by a vehicle position determining unit on a digital map (simply referred to as a “map” from here on) displayed on a display unit while superimposing the current position on the map. Further, the conventional navigation apparatus searches for a recommended Point of Interest (POI) information according to the current position of the vehicle which is determined by the vehicle position determining unit, and displays the recommended POI with the digital map on the display of the head unit.

The existing technology normally uses a low precision map and can merely indicate the POI position on the digital map rather than real information of the environment. It cannot indicate which building in reality is the right POI for the driver.

Another problem is that the road information gathered by such systems is incomplete and unprecise as a result of unpreventable errors of sensors. The navigation systems using a low precision map cannot provide precise enough information.

With the development of augmented reality, the demand of augmented navigation with high resolution information is raised recently. The task of the present invention is to provide a method and a device that can indicate precise information of the POI by using augmented reality. The precise POI information includes precise position of the POI and the type information of POI.

### SUMMARY

Embodiments of the present invention provide a method, a device and a system for displaying Point of Interest (POI) information for a vehicle, which enable an efficient and comfortable user experience by indicating precise information of the POIs, e.g. gas station, post office, shopping mall, hospital, etc.

Accordingly, a computer-implemented method for displaying Point of Interest (POI) information for a vehicle, comprises:

obtaining a digital map;
obtaining localization information of the vehicle;
obtaining coordinate information of the POI and type information of the POI from the digital map;
receiving reality image data from a camera mounted on the vehicle;
transforming the coordinates information of the POI from a coordinate system of the digital map to a coordinate system of the camera;
generating a guide sign indicating the POI in the coordinate system of the camera based on the coordinates information of the POI transformed to the coordinate system of the camera and the type information of the POI;
superimposing the guide sign indicating the POI on the image data received from the camera.

Firstly, the car, especially the in-car navigation system, comprises the digital map and received localization of the car from localization module, e.g. GPS. A High Definition (HD) Map provides a highly accurate and realistic representation of the roadway profile, including the POI information. The HD Map extends the range of view for the vehicle while enabling smoother, safer and more efficient driving scenarios. The HD Map can also be leveraged to fulfill a broad range of advanced driving applications. The POI information include coordinate information of the POI and type information of the POI. After selecting the POI according to the localization of the car, the in-car navigation system can show the POI information combined with the reality image sensed by the camera.

The navigation system according to the invention obtains and then transforms the coordinates of the POI from the coordinate system of the digital map to the coordinate system of the camera mounted on the car. After generating a POI guide sign indicating the place and/or type of the POI in the coordinate system of the camera according to coordinates of the POI transformed to the coordinate system of the camera. Then, the navigation system superimposes/overlays the lane guide sign on the image data received from the camera.

Advantageously, the navigation system can indicate which building in the real environment is actually the POI and simultaneously show the type of the POI, e.g. gas station, post office, shopping mall, hospital etc.

In a possible implementation manner, the digital map comprises coordinate information of POI.

In a possible implementation manner, the step “obtaining coordinates information and type information of the POI from the digital map” comprises: selecting the POI according to the localization information of the vehicle.

In a possible implementation manner, the step “transforming the coordinates information of the POI from a coordinate system of the digital map to a coordinate system of the camera” comprises: transforming the coordinate information of the POI using formula:

p_{c}=Tₑ⁻¹T_{c}⁻¹p_{w},

wherein p_{c} is a pixel position on the image data of the camera, Tₑ defines a posture of the vehicle in a coordinate system of the digital map, T_{c} defines a posture of the camera in a coordinate system of the vehicle, p_{w} is coordinate information of the POI.

In a possible implementation manner, Tₑ is calculated using:

$${T}_{e} = [ \begin{matrix}{R}_{e} & {p}_{e} \\ 0 & 1\end{matrix} ] ,$$

where Rₑ is the rotation matrix of the vehicle with respect to the digital map, and pₑ is the position of the vehicle in the coordinate system of the digital map.

In a possible implementation manner, the guide sign comprises: a POI position sign, and/or a POI type sign showing the type information of the POI.

In a possible implementation manner, the step “superimposing the guide sign indicating the POI on the image data received from the camera” comprises: projecting a semi-transparent guide sign of the POI onto the image data received from the camera.

Since the guide sign can indicate the POI on the real (moving) image of the environment and show the type of said POI, the navigation system according to the invention can help the driver to recognize the precise place of the POI even in dark environment, e.g. in the night.

According to a further aspect, a device for displaying Point of Interest (POI) information for a vehicle is provided. The device comprises:

a map obtaining module configured to obtain a digital map;
a localization module configured to obtain localization information of the vehicle; a POI information module configured to obtain coordinate information of the POI and type information of the POI from the digital map;
an image data module configured to receive reality image data from a camera mounted on the vehicle;
a transformation module configured to transform the coordinates information of the POI from a coordinate system of the digital map to a coordinate system of the camera;
a guide sign module configured to generate a guide sign indicating the POI in the coordinate system of the camera based on the coordinates information of the POI transformed to the coordinate system of the camera and the type information of the POI;
a superimposing module configured to superimpose the guide sign indicating the POI on the image data received from the camera.

In a possible implementation manner, the digital map comprises coordinate information of POI and type information of the POI.

In a possible implementation manner, the POI information module further configured to: select the POI according to the localization information of the vehicle.

In a possible implementation manner, the transformation module further configured to: transform the coordinate information of the POI using formula:

p_{c}=Tₑ⁻¹T_{c}⁻¹p_{w},

wherein p_{c} is a pixel position on the image data of the camera, Tₑ defines a posture of the vehicle in a coordinate system of the digital map, T_{c} defines a posture of the camera in a coordinate system of the vehicle, and p_{w} is coordinate information of the POI.

In a possible implementation manner, Tₑ is calculated using:

$${T}_{e} = [ \begin{matrix}{R}_{e} & {p}_{e} \\ 0 & 1\end{matrix} ] ,$$

where Rₑ is the rotation matrix of the vehicle with respect to the digital map, and pₑ is the position of the vehicle in the coordinate system of the digital map.

In a possible implementation manner, wherein superimposing module further configured to: project a semi-transparent guide sign of the POI onto the image data received from the camera.

According to a further aspect, the present invention provides a system for displaying Point of Interest (POI) information for a vehicle, comprising: an above mentioned device for displaying POI information for a vehicle, a storage medium comprising a digital map, a localization device configured to providing localization information of the vehicle, and a camera configured to sense the environment of the vehicle and output image data of the environment.

According to a further aspect, the present invention also provides a vehicle comprising the above mentioned system for displaying POI information for a vehicle.

Advantageously, the guide sign according to the invention can indicate the POI on the real (moving) image of the environment and simultaneously show the type of said POI. The navigation system can indicate which building in the real image of the environment the POI really is. Further, the navigation system according to the invention can help the driver to recognize the precise place of the POI even in dark environment, e.g. in the night.

### BRIEF DESCRIPTION OF DRAWINGS

To describe the technical solutions in the embodiments of the present invention more clearly, the following briefly introduces the accompanying drawings required for describing the embodiments. The accompanying drawings in the following description show merely some embodiments of the present invention, and a person of ordinary skill in the art may still derive other drawings from these accompanying drawings without creative efforts.

FIG. 1 is a schematic diagram of an embodiment of the method according to the present invention.

FIG. 2 is a schematic diagram of an embodiment of the device according to the present invention.

FIG. 3 is a schematic diagram of environment with roads and POI according to the visual angle of a camera.

FIG. 4 is a schematic diagram of an example of the POI guide sign of the augmented reality navigation according to the present invention.

FIG. 5 is a schematic diagram of a further example of the POI guide sign of the augmented reality navigation according to the present invention.

### DESCRIPTION OF EMBODIMENTS

The following clearly and completely describes the technical solutions in the embodiments of the present invention with reference to the accompanying drawings in the embodiments of the present invention. The described embodiments are some but not all of the embodiments of the present invention. All other embodiments obtained by a person of ordinary skill in the art based on the embodiments of the present invention without creative efforts shall fall within the protection scope of the present invention.

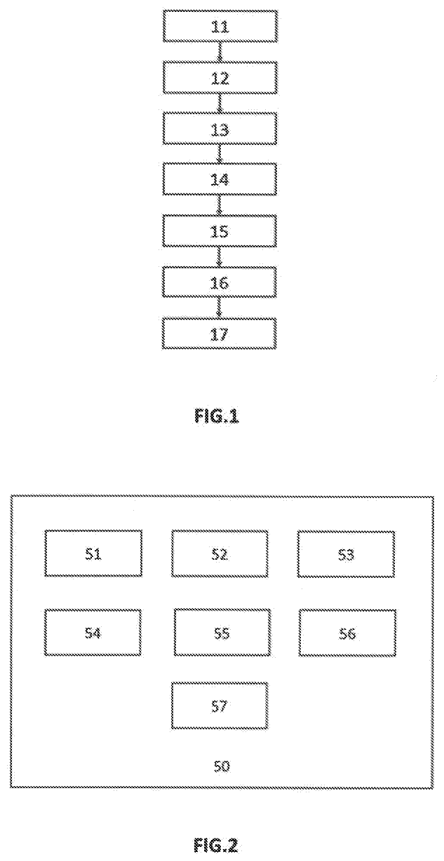

FIG. 1 shows a schematic flow chart diagram of an embodiment of the method 10 for displaying Point of Interest (POI) information for a vehicle, especially for displaying a guide sign indicating precise place of the POI as well as the type of the POI. The method can be implemented by a data processing device 50 shown in FIG. 2, e.g. a processor with corresponding computer program.

Firstly, the car, especially the in-car navigation system, obtains 11 the digital map and receives 12 localization of the car from localization module, e.g. GPS. A High Definition (HD) Map provides a highly accurate and realistic representation of a plurality of elements in the environment. The digital map comprises POI information including coordinate information and the type of the POI. The HD Map can also be leveraged to fulfill a broad range of advanced driving applications.

The vehicle comprises a camera mounted on the vehicle. The camera detect the environment of the vehicle and output the detected image date to the navigation system. The navigation system can receive image data from the camera.

After obtaining 13 coordinate information of the POI and type information of the POI from the digital map and receiving 14 reality image data from a camera mounted on the vehicle, the in-car navigation system can select the POI according to the localization information of the vehicle. Normally, the POI can also be filtered by predetermined types.

The navigation system according to the invention then transforms 15 the coordinate information of the POI from a coordinate system of the digital map to a coordinate system of the camera.

The coordinate information of the POI can be transformed using formula:

p_{c}=Tₑ⁻¹T_{c}⁻¹p_{w},

wherein p_{c} is a pixel position on the image data of the camera, Tₑ defines a posture of the vehicle in a coordinate system of the digital map, T_{c} defines a posture of the camera in a coordinate system of the vehicle, and p_{w} is coordinate information of the POI.

In addition, Tₑ can be calculated using:

$${T}_{e} = [ \begin{matrix}{R}_{e} & {p}_{e} \\ 0 & 1\end{matrix} ] ,$$

where Rₑ is the rotation matrix of the vehicle with respect to the digital map, and pₑ is the position of the vehicle in the coordinate system of the digital map.

Comparisons will be made between HD map information and sensor data of surroundings so that posture (position and orientation) of HAD car on HD map can be calculated. Here we define the posture of the car can be represented as transformation matrix Tₑ. Coordinates of Camera in HAD car frame and HAD car's position in HD map is combined to calculate camera's coordinates in HD map. Using sensor calibration techniques, the transformation matrix from the camera coordinate system to the ego vehicle coordinate system T_{c} can be obtained. In such a way, any 3D coordinate in the map world can be projected to the camera coordinate system.

Then, a guide sign indicating the POI in the coordinate system of the camera can be generated 16 based on the coordinates information of the POI transformed to the coordinate system of the camera and the type information of the POI.

After generating 16 the POI guide sign, the navigation system superimposes/overlays 17 the lane guide sign on the image data received from the camera.

HD map information will be loaded in the camera view based on position of camera in HD map. In this way, navigation information including current driving lane, lane change destination can be seen in the external camera's real-time video, since any coordinate in the world can be projected on the image using the formula p_{c}.

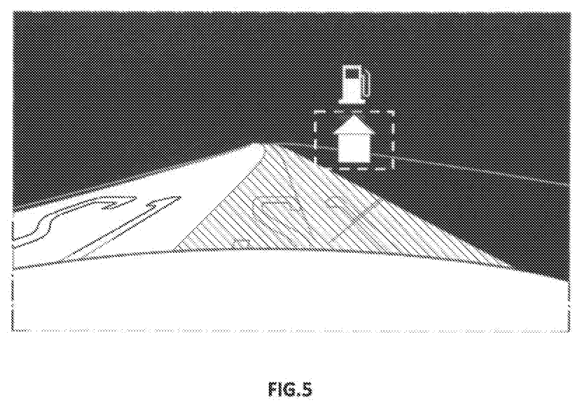

The POI position sign can be represented with a dotted line rectangular 121 and 122, as shown in FIG. 4, on the image and project each a dotted line rectangular 121 or 122 onto the real environmental image at the place where the POI building is located. The POI guide sign can be highlighted with a half transparent filling color.

A POI type sign indicating the type information of the POI can be represented with corresponding schematic sign 131 and 132, as shown in FIG. 4. Alternatively, the type information of the POI can be represented with literal indication.

Advantageously, the navigation system indicates the driver precisely where the POI building is located. In addition, since the guide sign can be highlighted, the navigation system according to the invention can help the driver to recognize the POI building where the luminance of the environment is not enough for recognizing the buildings, e.g. in the night.

In addition, the type of the POI indicating can be represented by the POI type signs with corresponding schematic signs.

Furthermore, the POI guide sign projected on the image can be semi-transparent, so that the environment on the real image received form the camera will not be obstructed.

FIG. 2 shows a schematic diagram of an embodiment of the device for augmented reality navigation for a vehicle, especially the device 50 for displaying a lane guide sign indicating precise lane boundaries and the width of the lane.

The device 50 for displaying Point of Interest (POI) information for a vehicle, a map obtaining module 51 configured to obtain a digital map; a localization module 52 configured to obtain localization information of the vehicle; a POI information module 53 configured to obtain coordinate information of the POI and type information of the POI from the digital map; an image data module 54 configured to receive reality image data from a camera mounted on the vehicle; a transformation module 55 configured to transform the coordinates information of the POI from a coordinate system of the digital map to a coordinate system of the camera; a guide sign module 56 configured to generate a guide sign indicating the POI in the coordinate system of the camera based on the coordinates information of the POI transformed to the coordinate system of the camera and the type information of the POI; a superimposing module 57 configured to superimpose the guide sign indicating the POI on the image data received from the camera.

The navigation system for displaying Point of Interest (POI) information for a vehicle comprises an above mentioned device for displaying POI information for a vehicle, a storage medium comprising a digital map, a localization device configured to providing localization information of the vehicle, and a camera configured to sense the environment of the vehicle and output image data of the environment.

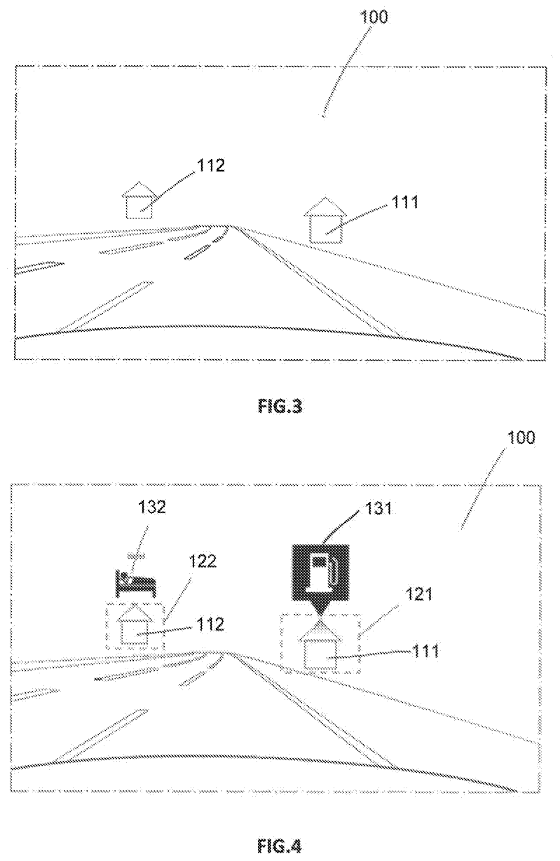

FIG. 3 shows a schematic diagram 100 of a street view with POIs corresponding to the visual angle of a camera. Accordingly, there are two POIs 111 and 112 on the image.

FIG. 4 is a schematic diagram of an example of the POI guide sign using the augmented reality according to the present invention.

The navigation system shows guide sign, i.e. dotted line rectangular 121 or 122, on the (moving) image of the reality recorded by the camera. The POI guidance sign 121 exactly corresponds to the location of the POI 111, and the POI guidance sign 122 exactly corresponds to the location of the POI 112. In addition, the type of the POI 111 and 112 are represented with corresponding schematic sign 131 (i.e. gas station) and 132 (i.e. Hotel).

The navigation system according to the invention indicate the place and the type of the POI based on the (moving) image of the real environment, but not a digital map. Therefore, the navigation system according to the invention can help the driver to recognize the place of the POI in a very easy and clear way.

FIG. 5 is a schematic diagram of a further example of the POI guide sign using the augmented reality navigation in a dark environment, e.g. in the night. The highlighted guidance area can help the driver to recognize the POI in a very clear way. Even if the building is hard to be recognized due to weak lights. Based on the highlighted POI guidance area shown by the navigation system, the driver can still know the location of the POI buildings. Thus, the navigation system according to the invention also enhance the safety of driving.

1.-15. (canceled)

16. A method for displaying Point of Interest (POI) information for a vehicle, comprising:
obtaining a digital map;
obtaining localization information of the vehicle;
obtaining coordinate information of the POI and type information of the POI from the digital map;
receiving reality image data from a camera mounted on the vehicle;
transforming the coordinate information of the POI from a coordinate system of the digital map to a coordinate system of the camera;
generating a guide sign indicating the POI in the coordinate system of the camera based on the coordinates information of the POI transformed to the coordinate system of the camera and the type information of the POI;
superimposing the guide sign indicating the POI on the image data received from the camera.

17. The method according to claim 16, wherein the digital map comprises coordinate information of POI.

18. The method according to claim 16, wherein the step of obtaining coordinates information and type information of the POI from the digital map comprises:
selecting the POI according to the localization information of the vehicle.

19. The method according to claim 16, wherein the step of transforming the coordinates information of the POI from a coordinate system of the digital map to a coordinate system of the camera comprises:
transforming the coordinate information of the POI using formula:
p_{c}=Tₑ⁻¹T_{c}⁻¹p_{w},
wherein p_{c} is a pixel position on the image data of the camera, Tₑ defines a posture of the vehicle in a coordinate system of the digital map, Tₑ defines a posture of the camera in a coordinate system of the vehicle, and p_{w} is coordinate information of the POI.

20. The method according to claim 19, wherein Tₑ is calculated using:
$${T}_{e} = [ \begin{matrix}{R}_{e} & {p}_{e} \\ 0 & 1\end{matrix} ] ,$$
where Rₑ is the rotation matrix of the vehicle with respect to the digital map, and pₑ is the position of the vehicle in the coordinate system of the digital map.

21. The method according to claim 16, wherein the guide sign comprises at least one of:
a POI position sign, and
a POI type sign showing the type information of the POI.

22. The method according to claim 16, wherein the step of superimposing the guide sign indicating the POI on the image data received from the camera comprises:
projecting a semi-transparent guide sign of the POI onto the image data received from the camera.

23. A device for displaying Point of Interest (POI) information for a vehicle, comprising:
a map obtaining module configured to obtain a digital map;
a localization module configured to obtain localization information of the vehicle;
a POI information module configured to obtain coordinate information of the POI and type information of the POI from the digital map;
an image data module configured to receive reality image data from a camera mounted on the vehicle;
a transformation module configured to transform the coordinates information of the POI from a coordinate system of the digital map to a coordinate system of the camera;
a guide sign module configured to generate a guide sign indicating the POI in the coordinate system of the camera based on the coordinates information of the POI transformed to the coordinate system of the camera and the type information of the POI; and
a superimposing module configured to superimpose the guide sign indicating the POI on the image data received from the camera.

24. The device according to claim 23, wherein the digital map comprises coordinate information of POI and type information of the POI.

25. The device according to claim 23, wherein the POI information module is further configured to:
select the POI according to the localization information of the vehicle.

26. The device according to claim 23, wherein the transformation module is further configured to:
transform the coordinate information of the POI using formula:
p_{c}=Tₑ⁻¹T_{c}⁻¹p_{w},
wherein p_{c} is a pixel position on the image data of the camera, Tₑ defines a posture of the vehicle in a coordinate system of the digital map, T_{c} defines a posture of the camera in a coordinate system of the vehicle, and p_{w} is coordinate information of the POI.

27. The device according to claim 26, wherein Tₑ is calculated using:
$${T}_{e} = [ \begin{matrix}{R}_{e} & {p}_{e} \\ 0 & 1\end{matrix} ] ,$$
where Rₑ is the rotation matrix of the vehicle with respect to the digital map, and pₑ is the position of the vehicle in the coordinate system of the digital map.

28. The device according to according to claim 23, wherein the superimposing module is further configured to:
project a semi-transparent guide sign of the POI onto the image data received from the camera.

29. A system for displaying Point of Interest (POI) information for a vehicle, comprising:
a device for displaying POI information for a vehicle according to claim 23, a storage medium comprising a digital map;
a localization device configured to provide localization information of the vehicle; and
a camera configured to sense the environment of the vehicle and output image data of the environment.

30. A vehicle comprising a system according to claim 29.
